(19) United States
(12) Patent Application Publication
(10) Pub. No.: US 2013/0045831 A1
(43) Pub. Date: Feb. 21, 2013

(54) DRIVE MECHANISM FOR INFINITELY VARIABLE TRANSMISSION

(71) Applicants: Christopher John Greenwood, Preston (GB); Andrew Damian De Freitas, Standish (GB)

(72) Inventors: Christopher John Greenwood, Preston (GB); Andrew Damian De Freitas, Standish (GB)

(73) Assignee: TOROTRAK (DEVELOPMENT) LIMITED, Lancashire (GB)

(21) Appl. No.: 13/505,091

(22) PCT Filed: Oct. 22, 2010
(86) PCT No.: PCT/GB2010/051781

§ 371 Date: Sep. 14, 2012

(30) Foreign Application Priority Data
Oct. 29, 2009 (GB) 0918957.2

(51) Int. Cl. F16H 15/38

(52) U.S. Cl. 476/40

(57) ABSTRACT

A variator transmission comprises an input disc (10), an input disc drive shaft (20) on which the input disc is mounted, a transmission input shaft (28) for rotating the input disc drive shaft (20), an output disc (12) facing the input disc and arranged to be rotatable coaxially therewith. The input and output discs have a toroidal cavity, rollers (14, 16), means for varying the inclination of the rollers, means (40, 42, 44) for applying to one of the input disc (10) and the output disc (12) a first end load proportional to the input torque applied by the transmission input shaft (28) and means (52, 54, 56) for applying a second end load proportional to the output torque of the variator.

The present invention relates to infinitely variable ratio transmission apparatus of the toroidal race rolling traction type, hereinafter referred to as a variator.

The basic form of variator comprises a toroidally-recessed input disc connected to an input drive shaft and a toroidally-recessed output disc arranged coaxially with respect to the input disc. A plurality of rollers is provided in the toroidal cavity defined between the input and output discs and power is transmitted from the input disc to the output disc by means of the rollers. An elasto-hydrodynamic oil film is present between the rollers and the input and output discs. The properties of the elasto-hydrodynamic fluid are such that when the fluid is compressed it becomes highly viscous, such that as pressure is exerted at the contact points between the rollers and the discs, the oil transmits power from one to the other.

In order to transmit the torque via the elasto-hydrodynamic fluid, it is necessary to clamp the rollers between the input and output discs. It is important that the correct clamping force (known as the “end load”) is applied. An excessive load will reduce efficiency and impair the durability of the variator. Insufficient end load will result in sliding contact between the rollers and the input and output discs.

The rollers are mounted on roller carriages which are subjected to transverse forces. In variators designed for use in relatively high power, high torque applications, the transverse forces are normally applied to the rollers by means of double-acting hydraulic pistons. The hydraulic pressure applied to the roller carriages is also normally used to produce an end load, since the desired end load is proportional to the transverse forces (known as the “reaction torque”) applied to the pistons controlling the roller carriages.

For applications of lower power and lower torque, it would be possible merely to scale down the variator used in the high power, high torque applications. However, there would still be a requirement for hydraulic pressure to be accurately applied and monitored in order for the variator to operate, and consequently the cost savings would not be particularly significant.

An alternative approach is to remove the hydraulic control completely and provide a constant end load by means of a spring and to replace the double-acting pistons controlling the rollers with a lever on which a pair of roller carriages is mounted, each of which carries a single roller. However, whilst such an arrangement produces acceptable results in certain applications, such as ride-on mowers, it is not sufficiently accurate or efficient to be used in the transmission of a small car or in an auxiliary drive application.

There is therefore a need for a variator which does not have the complexity of a hydraulically-actuated variator and yet which is more accurate than the very simple variators known thus far.

In accordance with the present invention, a variator transmission comprises:

an input disc;

an input disc drive shaft on which the input disc is mounted;

a transmission input shaft for rotating the input disc drive shaft;

an output disc facing the input disc and arranged to be rotatable coaxially therewith, the input and output discs defining between them a toroidal cavity;

a plurality of rollers located in the toroidal cavity, in rolling contact with the input and output discs;

means for varying the inclination of the plurality of rollers;

means for applying to one of the input disc and the output disc a first end load, proportional to the input torque applied to the variator by the transmission input shaft; and

means for applying a second end load, proportional to the output torque of the variator, to the same disc to which the first end load is applied.

With the above arrangement, the end load applied to the variator is proportional to the sum of the input and output torques and thus an accurate end load is provided mechanically, without the requirement for a high pressure hydraulic system.

Preferably, the input disc drive shaft passes through an aperture in the output disc.

The transmission input shaft is preferably displaceable angularly with respect to the input disc drive shaft.

Bearing means, e.g. a thrust bearing, are preferably located between the transmission input shaft and the input disc drive shaft.

In one embodiment, the first and second end loads are applied to the output disc.

The transmission may further comprise a ball and ramp connection between an end of the transmission input shaft and the output disc, for applying to the output disc the first end load, proportional to the input torque applied to the transmission input shaft.

The ball and ramp arrangement preferably comprises a plurality of balls and ramps.

The transmission may further comprise a splined sleeve connected to the input disc drive shaft, for transmitting the input torque to the input disc drive shaft, the splined sleeve forming part of the ball and ramp connection.

Preferably, the splined sleeve comprises a plurality of ramps of the ball and ramp connection.

The splined sleeve may comprise a shoulder.

Preferably, bearing means, e.g. a thrust bearing, are located between the shoulder of the splined sleeve and the output disc.

In another embodiment, the first and second end loads are applied to the input disc.

The transmission may further comprise spring means acting on one of the input and output discs, for applying a substantially constant first or second end load.

The use of spring means might be appropriate, for example, in circumstances where one of the input and output discs is expected to experience a substantially constant torque during operation. The use of a spring (e.g. a Belleville washer) can significantly reduce the complexity and cost of the transmission.

The transmission preferably further comprises an annular transmission output element located coaxially with the input and output discs adjacent to the output disc externally of the toroidal cavity.

Preferably, there is a ball and ramp connection between the output disc and the annular transmission output element.

The ball and ramp connection preferably comprises a plurality of balls and ramps.

The ramps are preferably in the annular output element and in the outer face of the output disc.

Bearing means, e.g. a thrust bearing, may be located between the annular output element and the transmission input shaft.

In one embodiment, the transmission input shaft passes through an aperture in the input disc and passes through an aperture in the output disc.

By way of example only, a specific embodiment of the present invention will now be described with reference to the accompanying drawings, in which:—

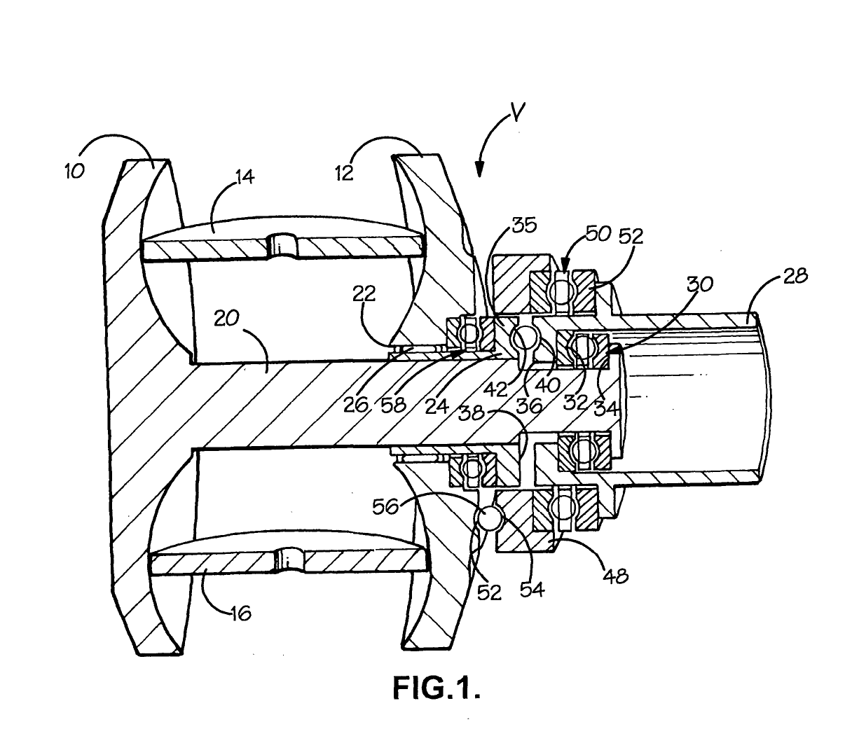

FIG. 1 is a longitudinal cross-section through a first embodiment of variator transmission in accordance with the present invention;

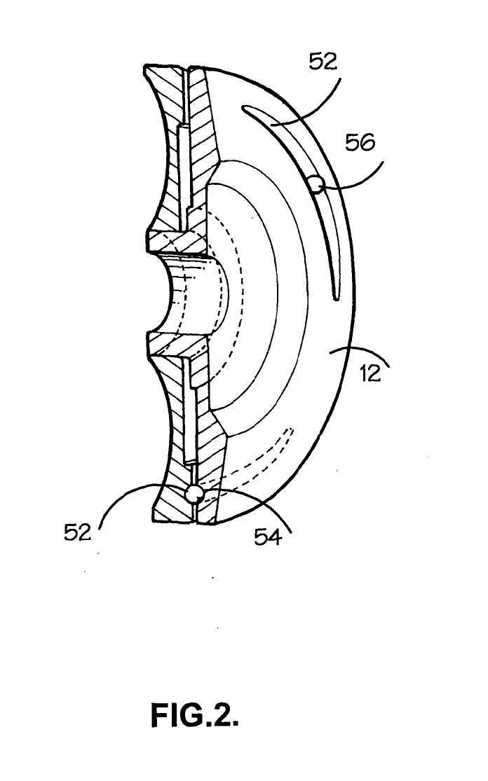

FIG. 2 is a perspective view of a portion of the exterior of the output disc of the variator of FIG. 1; and

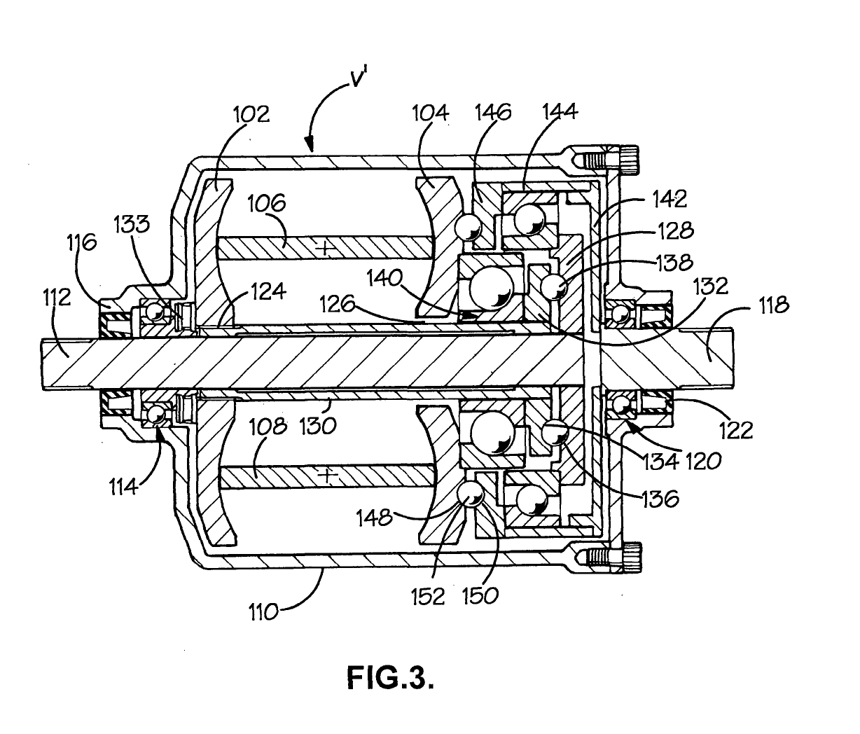

FIG. 3 is a longitudinal cross-section through a second embodiment of variator transmission in accordance with the present invention.

A first embodiment of continuously variable ratio transmission system is shown in FIG. 1 and comprises a variator V having a toroidally-recessed input disc 10 facing a toroidally-recessed output disc 12. Two rollers 14, 16 are rotatably mounted on roller carriages (not shown) in the toroidal cavity defined between the opposing toroidally-recessed faces of the input and output discs 10, 12, to transmit drive from the input disc 10 to the output disc 12 with a ratio which is variable by tilting the rollers 14, 16. The drive is actually transmitted by a very thin layer of elasto-hydrodynamic fluid between the rollers 14, 16 and the input and output discs 10, 12. The significant characteristic of the elasto-hydrodynamic fluid is that it becomes highly viscous when pressure is applied to it, allowing torque to be transmitted between the input and output discs and the rollers.

In practice, the rollers 14, 16 are mounted on roller carriages (not illustrated). By tilting the rollers, the effective ratio between the input and output discs can be varied.

The input disc 10 is mounted on an input disc drive shaft 20 which passes through an aperture 22 in the centre of the output disc 12. A sleeve 24 is splined to the input disc drive shaft and supports the output disc 12 on needle roller bearings 26.

The input disc drive shaft 20 is rotated by means of a hollow variator transmission input shaft 28, through the end of which the input disc drive shaft 20 passes. The transmission input shaft 28 is rotationally displaceable with respect to the input disc drive shaft by means of a thrust bearing 30 mounted between an annular end wall 32 of the hollow variator input shaft and an enlarged head portion 34 of the input disc drive shaft 20.

The outer face 36 of the annular end wall 32 of the hollow variator transmission input shaft 28 and the end face 38 of a shoulder portion 35 of the splined sleeve 24 are provided with three ramped grooves 40, 42 which receive a plurality of spherical balls 44. As the hollow variator transmission input shaft 28 turns slightly with respect to the input disc drive shaft 20, the balls 44 move along the ramped grooves 40, 42, thereby applying to the output disc 12 a first end load, proportional to the input torque applied to the variator by the transmission input shaft 28. The first end load is applied to the outer face of the output disc 12 via a thrust bearing 58 between the outer face of the output disc and the shoulder portion 35 of the splined sleeve 24.

An annular variator output gear 48 is rotatably mounted with respect to the hollow variator transmission input shaft 28 by means of a further thrust bearing 50, which also bears against a radially-extending flange 52 on the exterior surface of the transmission input shaft 28. The longitudinally outer face of the output disc 12 and the opposed face of the annular variator output gear 48 are similarly provided with three ramped grooves 52, 54 which each receive a ball 56, whereby rotation of the output disc 12 is transferred to the annular output gear 48.

At the same time, the action of the ball and ramp arrangement 52, 54, 56 applies to the output disc 12 a further end load which is proportional to the output torque of the variator.

Therefore, two independent end load components, one proportional to the input torque and one proportional to the output torque, are applied to the same disc, namely the output disc 12. In this way, the end load applied to the variator is proportional to a sum of the input and output torques and thus an accurate end load is provided mechanically, without the requirement for a high pressure hydraulic system.

A second embodiment of continuously variable ratio transmission system is shown in FIG. 3. The principles of operation of the second embodiment are the same as those of the first embodiment but the most notable difference from the first embodiment is that the input and output are located at opposite ends of the variator.

The transmission system of FIG. 3 comprises a variator V′ having a toroidally-recessed input disc 102 facing a toroidally-recessed output disc 104. Two rollers 106, 108 are rotatably mounted on roller carriages (not shown) in the toroidal cavity defined between the opposing toroidally-recessed faces of the input and output discs 102, 104 to transmit drive from the input disc 102 to the output 104 with a ratio which is variable by tilting the rollers 106, 108. The drive is actually transmitted by a very thin layer of elasto-hydrodynamic fluid between the rollers 106, 108 and the input and output discs 102, 104. The significant characteristic of the elasto-hydrodynamic fluid is that it becomes highly viscous when pressure is applied to it, allowing torque to be transmitted between the input and output discs and the rollers.

In practice, the rollers 106, 108 are mounted on roller carriages (not shown). By tilting the rollers, the effective ratio between the input and output discs can be varied.

The input and output discs 102, 104 and rollers 106, 108 are located in a generally cylindrical casing 110. A transmission input shaft 112, coaxial with the rotational axes of the input and output discs 102, 104 passes through an aperture in one end of the casing and is rotatably mounted with respect to the casing by means of a bearing 114. A conventional annular seal 116 seals the transmission input shaft 112 with respect to the casing 110.

A transmission output shaft 118, coaxial with the transmission output shaft 112, passes through an aperture in the opposite end of the casing 110 and is rotatably mounted with respect to the casing by means of a bearing 120. A conventional annular seal 112 seals the transmission output shaft 118 with respect to the casing 110. The transmission input shaft 112 does not rotate the input disc 102 directly. Instead, the transmission input shaft 112 passes through apertures 124, 126 in each of the input and output discs 102, 104 and terminates in a radially outwardly extending flange 128 adjacent to the opposite end wall of the casing. The rotation of the transmission input shaft 112 is transferred to the input disc 102 by means of a close-fitting elongate sleeve 130 surrounding the transmission input shaft 112 within the casing 110. One end of the sleeve terminates in a radially extending flange 132, adjacent to the flange 128 attached to the transmission input shaft 112 and the opposite end is splined to receive the input disc 102. A thrust bearing 133 is also located between the outer face of the input disc 102 and the bearing 114.

The facing surfaces of the two radially-outwardly extending flanges 128, 132 are generally planar but are provided with a plurality of cooperating ramped grooves 134, 136 respectively, each of which receives a spherical ball 138. As the transmission input shaft 112 rotates, it turns slightly with respect to the sleeve 130 and the balls 138 move along the ramped grooves 134, 136. This causes the sleeve 130 (and hence the input disc 102) to rotate and it also applies to the output disc 104 a first end load proportional to the input torque applied to the variator by the transmission input shaft 112. The first end load is applied to the outer face of the output disc 104 via a thrust bearing 140 between the outer face of the output disc and the radially-extending flange 132 of the elongate sleeve 130.

The transmission output shaft 118 is connected to an annular plate 142 located adjacent to the end wall of the casing 110. A cylindrical sleeve 144 extends longitudinally into the casing from the inner face of the annular plate and terminates in a radially inwardly-extending annular thrust plate 146 located adjacent to the outer face of the output disc 104. The opposed faces of the outer surface of the output disc 104 and the annular thrust plate 146 are generally planar, but are provided with a plurality of cooperating ramped grooves 148, 150 respectively, each of which receives a spherical ball 152. As the output disc 104 rotates in response to frictional engagement with the rollers 106, 108, the action of the ball and ramp arrangement 148, 150, 152 applies to the output disc 104 a second end load, which is proportional to the output torque of the variator. It will also be noted that a second thrust bearing 156 is located between the annular thrust plate 146 and the radially extending flange 128 of the transmission input shaft 112.

Therefore, as in the first embodiment, two independent end load components, one proportional to the input torque and one proportional to the output torque, are applied to the same disc, namely output disc 104. In this way, the end load applied across the variator is proportional to the sum of the output and input torques and thus an accurate end load is provided mechanically, without the requirement for a high pressure hydraulic system.

It should also be noted that in the above embodiment, the shaft 118 could equally be the transmission input shaft and the shaft 112 could be the transmission output shaft, in which case the two end loads applied to the disc 104 would actually be applied to the input disc of the variator.

The invention is not restricted to the details of the foregoing embodiments.

For example, although the embodiments described have the two end loads applied to the output disc, it would be possible, if desired, for both of the end loads to be applied to the input disc instead.

Moreover, although the end loads are described as being applied by means of a ball and ramp arrangement, this need not be the case. In particular, in circumstances where the transmission is to be used in circumstances where the input torque or the output torque is expected to be substantially constant, it would be possible to apply the end load to the disc experiencing the substantially constant torque by means of a spring (e.g. a Belleville washer acting an the outer face of the disc via a bearing). This would significantly reduce the complexity and cost of the transmission.

1. A variator transmission comprising:
an input disc;
an input disc drive shaft on which the input disc is mounted;
a transmission input shaft for rotating the input disc drive shaft;
an output disc facing the input disc and arranged to be rotatable coaxially therewith, the input and output discs defining between them a toroidal cavity;
a plurality of rollers located in the toroidal cavity, in rolling contact with the input and output discs;
means for varying the inclination of the plurality of rollers;
means for applying to one of the input disc and the output disc a first end load, proportional to the input torque applied to the variator by the transmission input shaft; and
means for applying a second end load, proportional to the output torque of the variator, to the same disc to which the first end load is applied.

2. A variator transmission as claimed in claim 1, wherein the input disc drive shaft passes through an aperture in the output disc.

3. A variator transmission as claimed in claim 2, wherein the transmission input shaft is displaceable angularly with respect to the input disc drive shaft.

4. A variator transmission as claimed in claim 3, comprising bearing means located between the transmission input shaft and the input disc drive shaft.

5. A variator transmission as claimed in claim 4, wherein the bearing means located between the transmission input shaft and the input disc drive shaft comprises a thrust bearing.

6. A variator transmission as claimed in claim 1, wherein the first and second end loads are applied to the output disc.

7. A variator transmission as claimed in claim 6, further comprising a ball and ramp connection between an end of the transmission input shaft and the output disc, for applying to the output disc the first end load, proportional to the input torque applied to the transmission input shaft.

8. A variator transmission as claimed in claim 7, wherein the ball and ramp arrangement comprises a plurality of balls and ramps.

9. A variator transmission as claimed in claim 7, further comprising a splined sleeve connected to the input disc drive shaft, for transmitting the input torque to the input disc drive shaft, the splined sleeve forming part of the ball and ramp connection.

10. A variator transmission as claimed in claim 9, wherein the splined sleeve comprises a plurality of ramps of the ball and ramp connection.

11. A variator transmission as claimed in claim 9, wherein the splined sleeve comprises a shoulder.

12. A variator transmission as claimed in claim 11, comprising bearing means located between the shoulder of the splined sleeve and the output disc.

13. A variator transmission as claimed in claim 12, wherein the 5 bearing means comprises a thrust bearing.

14. A variator transmission as claimed in claim 1, wherein the first and second end loads are applied to the input disc.

15. A variator transmission as claimed in claim 1, further comprising spring means acting on one of the input and output discs, for applying a substantially constant first or second end load.

16. A variator transmission as claimed in claim 1, further comprising an annular transmission output element located coaxially with the input and output discs adjacent to the output disc externally of the toroidal cavity.

17. A variator transmission as claimed in claim 16, further comprising a ball and ramp connection between the output disc and the annular transmission output element.

18. A variator transmission as claimed in claim 17, wherein the ball and ramp connection comprises a plurality of balls and ramps.

19. A variator transmission as claimed in claim 18, comprising ramps in the annular output element and in the outer face of the output disc.

20. A variator transmission as claimed in claim 16, further comprising bearing means between the annular output element and the transmission input shaft.

21. A variator transmission as claimed in claim 20 wherein the bearing means between the annular output element and the transmission input shaft comprises a thrust bearing.

22. A variator transmission as claimed in claim 1, wherein the transmission input shaft passes through an aperture in the input disc and passes through an aperture in the output disc.

23. (canceled)
